(19) United States
(12) Patent Application Publication
(10) Pub. No.: US 2024/0037582 A1
(43) Pub. Date: Feb. 1, 2024

(54) ALLOCATION OPTIMIZATION

(71) Applicant: MASTERCARD INTERNATIONAL INCORPORATED, PURCHASE, NY (US)

(72) Inventors: Nicola Mariella, Oranmore, Galway (IE); Stephen Patrick Flinter, Terenure, Dublin (IE); James Conway, Dublin (IE); Quentin Bragard, Dublin (IE)

(21) Appl. No.: 18/265,953

(22) PCT Filed: Dec. 8, 2021
(86) PCT No.: PCT/US2021/062400

§ 371 Date: Jun. 7, 2023

(30) Foreign Application Priority Data
Dec. 9, 2020 (GB) 2019377.7

(51) Int. Cl. G06Q 30/0202; G06Q 30/0207; G06Q 10/0631

(52) U.S. Cl. CPC G06Q 30/0202; G06Q 30/0207; G06Q 10/0631

(57) ABSTRACT

A system and computer-implemented method for optimising, by a quantum computer, an allocation of opportunities to recipients comprising: determining a plurality of opportunities to be allocated; determining a plurality of recipients to be allocated at least one of the plurality of opportunities; determining a respective acceptance likelihood of each of the plurality of recipients accepting each of the plurality of opportunities; determining a first constraint associated with a cost acceptance of each of the plurality of opportunities by the plurality of recipients; and determining an optimised allocation of the opportunities to the recipients based on the respective likelihoods and the first constraint, in the quantum computer.

### CROSS REFERENCE TO RELATED APPLICATION

This application claims the benefit of United Kingdom Patent Application No. 2019377.7, which was filed on Dec. 9, 2020, the entire contents of which are hereby incorporated by reference for all purposes.

### TECHNICAL FIELD

The present disclosure relates to quantum computing. In particular, the present disclosure relates to a computer-implemented method and corresponding computing device for optimising allocations.

### BACKGROUND

Quantum computers exploit the quantum super positioning characteristics of particles to determine the optimal solution to complex non-linear problems. Unlike classical computers where a classical memory bit will take either a value of “1” or a value of “0”; in a quantum computer, a quantum bit or “qubit” may take a value of “1”, “0” or a super position of “1” and “0”. By resolving the value of a plurality of qubits, the quantum computer can determine the minimum energy state of the qubits and so determine in one computation cycle the optimum solution to a given problem.

In order to exploit the processing efficiency of a quantum computer to solve a complex real world problem, the real world problem and variable may need to be expressed to the quantum computer in a resolvable manner. Determining how to express the problem and variables may be a computationally expensive task which may require more processing cycles than would be needed to solve the problem using a traditional iterative method.

The present disclosure has been devised to mitigate or overcome at least some of the above-mentioned problems.

### SUMMARY OF THE DISCLOSURE

According to a first aspect there is provided a computer-implemented method for optimising, by a quantum computer, an allocation of opportunities to recipients comprising: determining a plurality of opportunities to be allocated; determining a plurality of recipients to be allocated at least one of the plurality of opportunities; determining a respective acceptance likelihood of each of the plurality of recipients accepting each of the plurality of opportunities; determining a first constraint associated with a cost acceptance of each of the plurality of opportunities by the plurality of recipients; and determining an optimised allocation of the opportunities to the recipients based on the respective likelihoods and the first constraint, in the quantum computer.

The method may further comprise: determining a second constraint associated with the uptake of each of the plurality of opportunities by the plurality of recipients; and using the second constrain in the determining of the optimised allocation.

The quantum computer may be further configured to output the optimised allocation.

The first constraint is may be a budget constraint.

The second constraint may indicate that a plurality of opportunities are mutually exclusive.

The determination of the acceptance likelihood may comprise populating an n by m matrix of values, wherein each respective value provides an indication of the likelihood of a recipient m accepting an opportunity n.

The optimised allocation may be provided as a n by m matrix of binary values, wherein a first binary value provides an indication that respective opportunity has been allocated to a recipient and a second binary value provides an indication that a respective opportunity has not been allocated to a recipient.

The first constraint may be provided by a vector of values, wherein each respective value provides an indication of a first constraint associated with a respective opportunity.

The second constraint may be provided by a vector of values, wherein each respective value provides an indication of a second constraint associated with a respective opportunity.

The second constraint may be provided by a vector of values, wherein each respective value provides an indication of a second constraint associated with a respective recipient.

The opportunity may be an offer made available by a merchant.

The recipient is may be a card holder.

The first constraint may be a budget made available by a merchant.

The plurality of recipients may be arranged into groups of recipients and the allocation of opportunities may be made to said groups of recipients. In this way, the required computing power may be reduced as the number of recipients is replaced with the, relatively lower, number of groups.

Each recipient may share a common interest with each other recipient in the respective group of recipients. For example, each recipient in a respective group may have an interest in travel. Accordingly, an offer of a credit card rewarding use of the credit card with loyalty travel points, tokens or discounts may be of interest to each recipient in said group.

At least one recipient may be a member of a plurality of groups of recipients. A significant number of recipients may be a member of a plurality of groups. For example, at least 5%, at least 10%, at least 20%, at least 50% or at least 75% of recipients may be a member of a plurality of groups of recipients. Each recipient may be a member of a plurality of groups of recipients.

Each recipient may be a member of a limited number of groups of recipients. The limited number of groups may be less than the total number of groups, such that no recipient is a member of each and/or every group of recipients. Each recipient may be a member of a maximum of 2, 3, 4, 5, 10, 15, 20, 25 or 50 groups of recipients. Any other suitable maximum number may be used. The maximum number of groups and/or number of recipients within each group may be selected to meet a constraint of the available computing power.

During the determination of the optimised allocation, a weight or weighting may be applied to each group of recipients. The weight applied to a group may be related to the number of recipients within the group. In this way, a group including a relatively larger number of recipients may be given a greater weight and therefore be given more importance.

The method may further comprise determining, based on a number of recipients within a group of recipients and the first constraint, that the first constraint cannot be met, and splitting the group of recipients into two further groups of recipients. The splitting of groups of recipients may be performed iteratively until the first constraint is met or can be met.

In one example, the plurality of recipients may be a plurality of distributed processors and the plurality of opportunities may be a plurality of computational sub-problems to be solved. As such, a large or complex computational problem may be split into a plurality of computational sub-problems and allocated to the plurality of distributed processors. The acceptance likelihood may be related to a likelihood of the respective distributed processor being able to complete the computational sub-problem. The cost acceptance may be related to a time required for the distributed processor to solve the computational sub-problem. The time required to solve the computational sub-problem may include a computation time and a queue time, should the distributed processor be used for other functions. In this way, the computational sub-problems may be allocated to the plurality of distributed processors in such a way as to make efficient use of available computational resources and to reduce the time taken to solve the computational problem. Alternatively or additionally, the cost acceptance may be related to a monetary cost related to the use of the respective distributed processor, such that the total monetary cost required to solve the computational problem is reduced. The distributed processors may be grouped into groups of processors in the way described above. The distributed processors may be grouped based on shared characteristics. For example, each processor within a first group may be a media-specific processor, whilst each processor within a second group may be an application-specific system processor (ASSP). Accordingly, a sub-problem related to processing of media may be allocated to the first group. In this way, a characteristic of the processors may be considered, and the most appropriate group of processors may be considered for the respective sub-problem.

There is provided according to a second aspect a system comprising a classical computer and a quantum computer wherein: the classical computer comprises a computational unit configured to: determine a plurality of opportunities to be allocated; determine a plurality of recipients to be allocated at least one of the plurality of opportunities; determine a respective likelihood of each of the plurality of recipients accepting each of the plurality of opportunities; and determining a budget associated with a cost uptake of each of the plurality of opportunities by the plurality of recipients; and wherein the quantum computer comprises a quantum computational unit configured to: determine an optimised allocation of the opportunities to the recipients based on the respective likelihoods and the budget.

There is provided according to a third aspect a computer program product comprising instructions which, when the program is executed by a classical computer and a quantum computer, cause the classical computer and quantum computer to carry out the method of the first aspect.

There is provided according to a fourth aspect a computer-readable storage medium comprising instructions which, when executed by a classical computer and a quantum computer, cause the classical computer and quantum computer to carry out the method of the first aspect.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the disclosure will now be described, by way of example only, with reference to the accompanying drawings, in which:

FIG. 1 is a computing system;

FIG. 2 shows an opportunity allocation system;

FIG. 3 is a method performed by the computing system; and

FIG. 4 is a method for optimising an allocation of opportunities to recipients;

### DETAILED DESCRIPTION

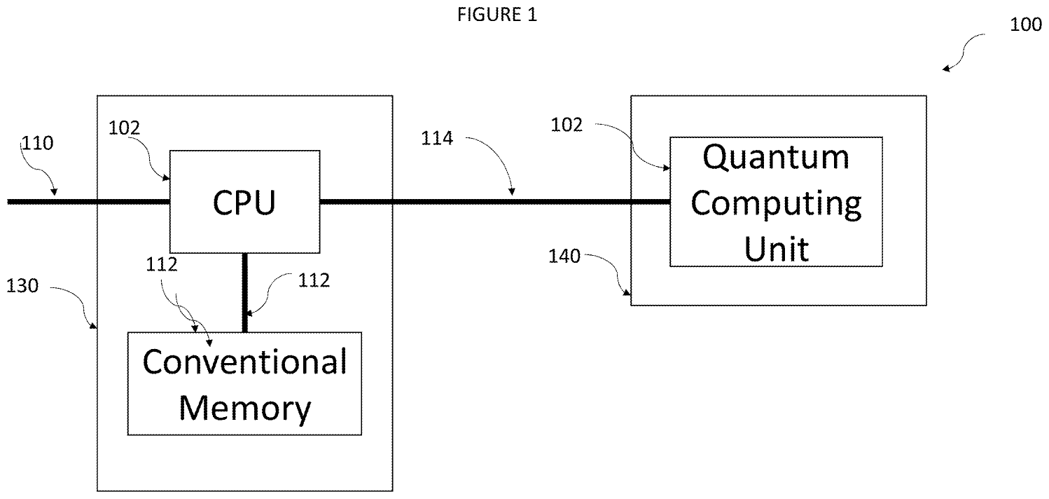

FIG. 1 shows a computing system 100 comprising a classical computer 130. The classical computer 130 comprises a CPU 102 coupled to provide transactions to and receive transactions from a conventional memory 104 by means of a memory interface 112. Input information may be received by the CPU from an interface 110. Output information may be provided by the CPU to the interface 110. The classical computer 130 may further comprise additional classical computing elements as known in the art (not shown).

The classical computer 130 is coupled to a quantum computer 140. The quantum computer 140 comprises a quantum computing unit 106. The quantum computing unit 106 comprises a plurality of qubits and is configured to receive the expressions from the classical computer and resolve the problem using a plurality of qubits.

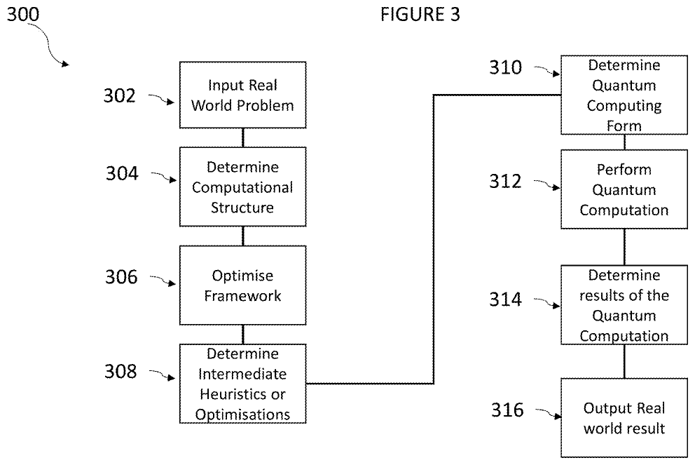

FIG. 3 shows a method 300 of operation for the computing system 100. A real world problem is input 302 into the classical computer 130. The classical computer 130 determines a computational structure 304 for the problem and optimises the framework 306. Then intermediate heuristics or optimisations are determined 308. The optimisations are then passed to the quantum computer 140 to determine the quantum computing form 310. The quantum computation 312 is then performed and the results passed back to the classical computer 130 to determine the results of the quantum computation. Then the result is output to the real world 316.

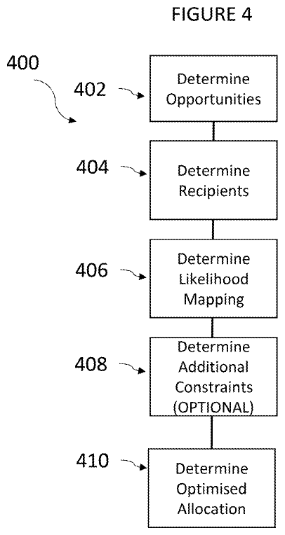

FIG. 4 shows an allocation method 400 according to some embodiments. In the allocation method 400, a plurality of opportunities 402 are determined and a plurality of recipients are determined 404. A likelihood mapping is determined 406 wherein the mapping provides an indication of the likelihood that a recipient will accept an opportunity. A budget is determined 408 wherein the budget provides an indication of constraints which need to be applied to the system. In some embodiments additional optional constraints may also be determined 410. An optimised allocation mapping is then determined 412 by resolving the likelihood mapping with the budget and option additional constraints.

In some embodiments, steps 402, 404, 406, 408 and optional step 410 are performed by the classical computer 130. Steps 402 and 404 may be performed in parallel or in any order. Steps 406, 408 and optional step 410 may be performed in parallel or in any order.

In some embodiments the allocation mapping may be a maximisation result. In some embodiments the allocation mapping may be a minimisation result.

In some embodiments, step 412 is performed by the quantum computer 140.

Some embodiments will be described in term of their application Personalized Card-Linked Offer (PCLO) system. PCLO systems operate by targeting cardholders based on transaction history. The cardholders are scored based on their likelihood of redeeming an offer. Multiple offers may then be assigned to the card holder based on following a set of constraints. Some existing systems, the offer may be assigned on a “first-come first-serve basis with no optimisation. Existing optimisation solutions require a trade-off between accuracy of the allocation of offers to cardholders and the number of offers being provided and cardholders targeted at a time.

In existing systems, a small number of cardholders may often have many offers allocated to them, regardless of whether it is an offer which is likely to be of interest to them, whilst other cardholders may have no offers allocated to them even though a particular offer may have been of value to them.

Some embodiments may use Quadratic Unconstrained Binary Optimization (QUBO) and leverage Quantum Computing in order to improve on the results of the offers being used without having to unduly limit the number of offers being provided and cardholders targeted at a time. In other words, some embodiments may optimise the allocation of offers to cardholders within a budget such that all of the available offers are likely to be used a cardholder.

The QUBO framework may express a real world problem as an energy function which can be provided to the quantum computer. The variables identified in relation to the real world problem are mapped to the variables of the QUBO energy function. The QUBO energy function may be thought of as a matrix wherein each value in the matrix forms expresses the relationship between two different qubits in the quantum computer. For simplicity some embodiments herein may be described in terms of a problem expressed in a two-dimensional QUBO energy function. However, other embodiments may express problems in terms of three or more dimensions. Once the energy function has been input to the quantum computer, the physical properties of the quantum computer will cause the function to resolve to a minimum value landscape which may be output as an optimisation of the result.

In order to determine optimal switching configuration that minimises the overall cost of the transaction processing the problem may be formulated in terms of a Quadratic unconstrained binary optimization (QUBO) framework.

QUBO is a mathematical formulation for combinatorial optimisation problems. QUBO is directly related to the physical model behind quantum annealers, so by expressing a problem in terms of QUBO the quantum dynamics may be exploited to optimise a process. Some embodiments may provide a custom modelling of the QUBO energy landscape that minimises a cost function proportional to the monetary cost of the transactions switching. In some embodiments, this structure may also comprise the discount conditioned to the volume routed through each network.

This assignment problem may be described as a combinatorial optimization problem that has multiple variants. In some embodiments it may be assimilated to a quadratic assignment problem with a non-deterministic polynomial-time hardness and so may be complex for a classical computing system to solve.

Some embodiments may maximize the overall return of a set of offers by finding the optimum cardholders assignment possible against a plurality of constraints. In some embodiments the first constraint may be that the system must meet a predetermined budget. In some embodiments the predetermined budget may have an acceptable error margin associated with it and so may be defined as a soft constraint. In some embodiments the second constraint may be that each cardholder may only receive up to a certain number of offers. This may be for the duration of the exercise or within a particular period. This type of constraint may be defined as a hard constraint.

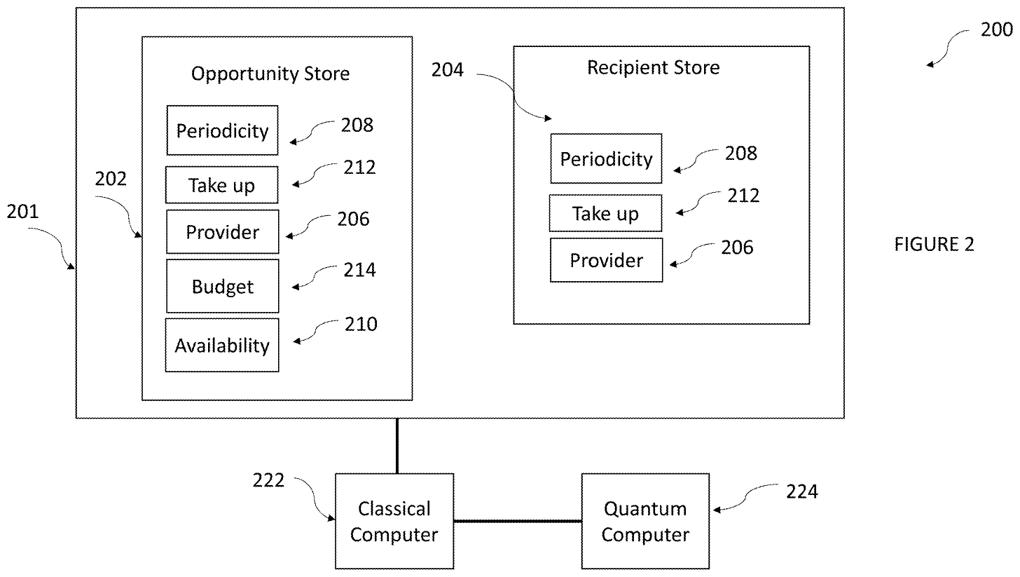

Some embodiments are described in terms of the opportunity allocation system shown in FIG. 2. The allocation system 201 comprises an opportunities unit 202 and a recipient unit 204. The opportunities unit 202 comprises opportunity provider information 206, opportunity periodicity information 208, opportunity availability information 210, opportunity take up information 212 and opportunity budget information 214. The recipient unit 204 comprises recipient periodicity information 216, recipient take up information 218 and recipient preference information 220. The allocation system 201 may provide at least one piece of information from the opportunities unit 202 and at least one piece of information from the recipient unit 204 to a classical computer 222. The classical computer 222 may provide an expression of the information provided by the allocation system 201 and a problem to be optimised to a quantum computer 224. The expression may be formed such that the quantum computer is able to resolve the information provided by the allocation system to provide an optimised answer to the problem.

In some embodiments the allocation system may have a plurality of potential opportunities and a plurality of potential recipients. The classical computer may express the opportunities and recipients and their respective constraints to the quantum computer which will then provide an allocation of the opportunities to the recipients such that the likelihood of uptake of opportunities by recipients is maximised.

In some embodiments the opportunities unit may further comprise additional information related to the characteristics of an opportunity and/or its likelihood of adoption by a recipient. In some embodiments the recipient unit may comprise further additional information related to a recipient and their likelihood of adopting an opportunity.

The opportunity provider information 206 may be information relating to the identities providing opportunities. For example, but not limited to merchants providing discount offers. The opportunity periodicity information 208 may be information related to the time during which an opportunity is available and/or the time between which opportunities are available for a particular opportunity provider. For example, but not limited to the date during which a discount offer from a merchant is available. The opportunity availability information 210 may be information related to the number of opportunities which are available. For example, but not limited to the number of times a discount offer from a merchant may be used or made available to a recipient. The opportunity take up information 212 may be information related to the number of times a type of opportunity has been used in the past by a type of recipient. For example, but not limited to the number of times a discount code from a merchant has been redeemed by a customer. The opportunity budget information 214 may be information relating to the available budget for funding one or more opportunities. For example, but not limited to the amount of money available to fund a discount code provided by a merchant.

The recipient periodicity information 216 may be information related to how often a recipient wishes to receive information about opportunities. For example, but not limited to the number of emails containing merchant discount codes a recipient wishes to receive per week. The recipient take up information 218 may be information related to how often a recipient redeems an offer. For example, but not limited to the number of time a recipient has used a discount code from a particular merchant. The recipient preference information 220 may be information related to preferences expressed by a recipient. For example, but not limited to particular merchants from which a recipient would like to receive discount codes.

In some embodiments the recipient information may be information which an individual has provided in order to receive targeted opportunities. In some embodiments the recipient information may be determined based on factors including, but not limited to market trends, or historic trends.

Some embodiments are described using a cardholder offer system as a detailed example below. In this system the allocation information may comprise a number of cardholders from an issuer's portfolio; a number of offers that may be sent to those cardholders; a periodic schedule for sending offers to cardholders; and a number of offers that can be sent to each cardholder. For example, each cardholder might receive an email with 10 offers, drawn from the hundreds or thousands of offers that are available.

In some embodiment the number of cardholders may be in the order of millions. In some embodiment the number of offers may be in the order of hundreds or thousands. In some embodiment the periodic schedule for sending offers may be in the order of one per week. In some embodiments the number of offer that can be sent to each cardholder may be in the order of tens.

In some embodiments each offer is linked to a given merchant, and each merchant may have one or more offers live in the system at any given time. Each merchant may also have a budget $B to cover the costs associated with a given set of one or more offers. In some embodiments this budget may only be used when a cardholder redeems an offer. In some embodiments the budget may not be exceeded. Thus, the budget used may be a function of the number of offer redemptions available from the pool of offers provided by a merchant.

In some embodiments, the offer may be defined in a manner such as spend $50 with Merchant X on your Card Y, to receive 10% discount on your next purchase. This type of offer is known as a card-linked offer (CFO), as the receipt of the benefit or reward in the offer is linked directly to usage of a particular card.

In some embodiments a separate system has may determine created a propensity or expected return that a given cardholder will accept a given offer, for all possible cardholders and offers. The resulting offer-cardholder matrix is shown in Table 1.

TABLE 1
An Offer-Cardholder Matrix

| Offer | Cardholder 1 | Cardholder 2 | . . . | Cardholder n |
|---|---|---|---|---|
| Offer 1 | 0.4 | 0.2 | . . . | 2.3 |
| Offer 2 | 0.02 | 1.7 | . . . | 0.1 |
| . . . | . . . | . . . | . . . | . . . |
| Offer m | 0.1 | 0.07 | . . . | 0.35 |

Where each entry (i,j) corresponds to the expected return that a cardholder i will accept or redeem an offer j. The indices i and j are used to address rows and columns in the table respectively throughout this disclosure.

Thus table 1 maps a first set of available offers, offer 1 to offer m against a second set of available cardholders, cardholder 1 to cardholder n. The entry for each cardholder—offer intersection provides a tendency for the cardholder to accept or use the offer. For example, the tendency for a cardholder n to accept offer 1 is 2.3 whilst the tendency of cardholder 2 to accept the offer 1 is 0.2. This expected return value may be calculated using known techniques.

In some embodiments the tendency of uptake for available offers may be obtained through statistical processing of historic acquisitions. In some embodiments this may be based on the assumption that a user tends to have a narrow set of interests which is somehow stable along a certain time-frame.

Some embodiments may find an allocation of the offers per cardholder which maximises the overall return of the campaigns, based on expectation of redemption, subject to: maximizing the usage of the budget available to the Merchant, and hence maximise the return on investment made by Merchant for the program.

Some embodiments may structure the expressions provided to the quantum computer such the quantum computer provides an optimised assignment of the opportunities or offers to the recipients or cardholders. In some embodiments, this assignment may comprise linking cardholders and offers subject to at least one constraint, including but not limited to a limited budget, a number of offers per cardholder or mutual exclusion of groups of offers with respect to the cardholder.

In some embodiments expressions provided to the quantum computer are defined such that the solution provided by the quantum computer maximises of the overall expected return. This may be calculated using the expected value associated with each pair cardholder-offer.

In some embodiments expressions provided to the quantum computer are defined such that the solution provided by the quantum computer minimises the overall expected rejection of the offers. This may be calculated using the expected value associated with each cardholder-offer pair.

In some embodiments, table 1 may be viewed as an m by n sized matrix, R, in which each entry rᵢⱼ represents the expected return when an offer I is associated with a cardholder j.

In some embodiments the formulation of the expected return may be proportional to the likelihood of redemption, and so they may be considered equivalent.

The quantum computer may output a matrix X which indicates whether an offer should or should not be allocated to a particular cardholder. In some embodiments each element xᵢⱼ of the matrix X may be set as a as a binary variable, for example where xᵢⱼ∈{0,1}, which reflects the link of offer i to cardholder j. In some embodiments the value 1 may represents the association or allocation of the offer to the cardholder and the value 0 may represent the absence of such an association or that the offer has not been allocated to the cardholder.

As described above, the variables and the expected returns rᵢⱼ are aggregated into the matrices X and R respectively. The number of offers that can be assigned to each cardholder may be bounded by a constant k.

Each offer has a corresponding budget. This budget may be given in terms of the number of instances that the offer can be released or allocated to a cardholder. The budget may also be given as a spending interval instead of a single value. Thus when the budget for an offer i is be represented bᵢ, then the budget constraint may be expressed as:

bᵢ^{L}≤bᵢ≤bᵢ^{U}

where bᵢ^{L} and bᵢ^{U} are the lower and upper bounds of the allowed spending respectively. In some embodiments where the budget is a soft constraint this mechanism may be used to exceed the budget. This may occur in situations when there is no certainty in regards to the number of redemptions but the offer provider has decided to over allocate opportunities in order to increase the likelihood of adoption.

The budget excess can be calculated using the expected redemption rate. The budget interval may be represented in vector form by means of the vectors:

$${b}^{L} = [ \begin{matrix}{b}_{1}^{L} \\ {b}_{2}^{L} \\ {b}_{m}^{L}\end{matrix} ] \\ And \\ {b}^{U} = [ \begin{matrix}{b}_{1}^{U} \\ {b}_{2}^{U} \\ {b}_{m}^{U}\end{matrix} ]$$

The optimisation problem may be formulated as:

$${min}_{\{ {x}_{ij} \}} ( - {\sum }_{i = 1}^{m} {\sum }_{j = 1}^{n} {x}_{ij} {r}_{ij} ) = {min}_{X} - tr ( {XR}^{T} )$$

With the additional limitation of:

$${\sum }_{i = 1}^{m} {x}_{ij} \leq k , ∀ j \to {X}^{T} 1 \leq k 1$$

In some embodiments X^{T}1 may express the sum of xo in a matrix rather than a sum format. In some embodiments 1 may be a vector wherein each of the n values within the vector has a value of 1 and the number n of values is dependent on the size of the matrix expression. The additional limitation which limits the number of offers associated to each cardholder to k, and

$${b}_{i}^{L} \leq {\sum }_{j = 1}^{n} {x}_{ij} \leq {b}_{i}^{U} , ∀ i \to {b}^{L} \leq X 1 \leq {b}^{U}$$

which constrains the available budget each offer (indexed by i) to the minimum and maximum thresholds [bᵢ^{L}, bᵢ^{U}] as described above.

Some optional embodiments may comprise groups of mutually exclusive offers, that is, a cardholder cannot be proposed with more than one offer from such group. Thus when, for example, when a group of offers:

{gh}⊆[1,m}

are mutually exclusive, then the constraint may be formalised as

$${\sum }_{i ∈ \{ {g}_{h}} {x}_{ij} \leq 1 , ∀ j \to {X}^{T} g \leq 1$$

where g is a binary vector representing the membership to the group.

Some aspects of the invention may provide a better way of assigning cardholder to offers. Some embodiments may improve the global results of a set of offers.

Whilst some embodiments have been described in terms of allocation of card offers to card holders, the described embodiments may be applied to any system designed to allocate opportunities to recipients by modifying the opportunity and recipient information.

Some embodiments may assign housing “opportunities” to “recipient” families on a housing waiting list. In such embodiments, the values in the matrix R may be determined based on a suitability of a home for a particular family. For example, but not limited to a one bedroom home may be more suitable for a single member household than a family of four, whilst a three bedroom home may be more suitable for the family of four than a single member household. The budget constraints may be determined based on a variety of factors comprising, but not limited to rental cost or distance from key infrastructure. Of course, it will be appreciated that the application of embodiments to some problems, such as housing, may provide a recommended starting allocation and rather than a final mandated mapping and the outcome may be manually adjusted before execution.

Some embodiments may assign computer processing tasks to recipient processors, for example, but not limited to CPUs, GPUs, DSPs, GP-GPUs, quantum processor and/or processors optimised or artificial intelligence tasks. In such embodiments, the processors are the recipients and the processing tasks are the opportunities. In such embodiments, in for example, a complex cloud computing infrastructure a large number of tasks, of differing types, requiring execution may be received and a large number of processors may be housed within the cloud computing infrastructure. The values in the matrix R may be determined based on an ability for a particular processor to efficiently execute a particular type of transaction. The budget constraints may determined based on at least one processor limitation for example, but not limited to required processing power, required processor speed, required processing accuracy or processor cost. The optional additional constraints may be determined based on factors comprising, but not limited to processor output dependencies, processor maintenance schedules or geographic limitations, such as where data may be stored or processed in accordance with local laws.

In some embodiments the number of recipients may be in the order of millions. In some embodiments the number of opportunities may be in the order of hundreds or thousands. In some embodiments the periodic schedule for sending opportunities may be in the order of one per week. In some embodiments the number of opportunities that may be sent to each recipient may be in the order of tens.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims.

It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The tern“and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for optimizing, by a quantum computer, an allocation of opportunities to recipients, the method comprising:
determining a plurality of opportunities to be allocated;
determining a plurality of recipients to be allocated at least one of the plurality of opportunities;
determining a respective acceptance likelihood of each of the plurality of recipients accepting each of the plurality of opportunities;
determining a first constraint associated with a cost acceptance of each of the plurality of opportunities by the plurality of recipients; and
determining an optimized allocation of the opportunities to the recipients based on the respective likelihoods and the first constraint, in the quantum computer.

2. The method of claim 1, further comprising:
determining a second constraint associated with the uptake of each of the plurality of opportunities by the plurality of recipients; and
using the second constrain in the determining of the optimized allocation.

3. The method of claim 1, wherein the quantum computer is further configured to output the optimized allocation.

4. The method of claim 2, wherein the first constraint is a budget constraint; and/or
wherein the second constraint indicates that a plurality of opportunities are mutually exclusive.

5. (canceled)

6. The method of claim 1, wherein the determination of the acceptance likelihood comprises populating an n by m matrix of values, wherein each respective value provides an indication of the likelihood of a recipient m accepting an opportunity n.

7. The method of claim 6, wherein the optimized allocation is provided as a n by m matrix of binary values, wherein a first binary value provides an indication that respective opportunity has been allocated to a recipient and a second binary value provides an indication that a respective opportunity has not been allocated to a recipient.

8. The method of claim 6, wherein the first constraint is provided by a vector of values, wherein each respective value provides an indication of a first constraint associated with a respective opportunity.

9. The method of claim 2, wherein the second constraint is provided by a vector of values, wherein each respective value provides an indication of a second constraint associated with a respective opportunity; and/or
wherein the second constraint is provided by a vector of values, wherein each respective value provides an indication of a second constraint associated with a respective recipient.

10. (canceled)

11. The method of claim 1, wherein the opportunity is an offer made available by a merchant.

12. The method of claim 1, wherein the recipient is a card holder.

13. The method of claim 1, wherein the first constraint is a budget made available by a merchant.

14. The method of claim 1, wherein the plurality of recipients are arranged into groups of recipients and the allocation of opportunities is made to said groups of recipients.

15. The method of claim 14, wherein each recipient shares a common interest with each other recipient in the respective group of recipients.

16. The method of claim 14, wherein at least one recipient is a member of a plurality of groups of recipients.

17. The method of claim 16, wherein each recipient is a member of a limited number of groups of recipients; and/or
wherein each recipient is a member of a maximum of 4 groups of recipients.

18. (canceled)

19. The method of claim 14, wherein, during the determination of the optimized allocation, a weight is applied to each group of recipients, further wherein the weight applied to a group is related to the number of recipients within the group.

20. The method of claim 19, further comprising determining, based on a number of recipients within a group of recipients and the first constraint, that the first constraint cannot be met, and splitting the group of recipients into two further groups of recipients.

21. The method of claim 20, wherein the splitting of groups of recipients is performed iteratively until the first constraint is met.

22. A system comprising a classical computer and a quantum computer, wherein:
the classical computer comprises a computational unit configured to:
determine a plurality of opportunities to be allocated;
determine a plurality of recipients to be allocated at least one of the plurality of opportunities;
determine a respective likelihood of each of the plurality of recipients accepting each of the plurality of opportunities; and
determining a budget associated with a cost uptake of each of the plurality of opportunities by the plurality of recipients; and
wherein the quantum computer comprises a quantum computational unit configured to:
determine an optimized allocation of the opportunities to the recipients based on the respective likelihoods and the budget.

23.-24. (canceled)

25. A non-transitory computer-readable storage medium including executable instructions, which when executed by at least one processor, cause the at least one processor to:
determine a plurality of opportunities to be allocated;
determine a plurality of recipients to be allocated at least one of the plurality of opportunities;
determine a respective likelihood of each of the plurality of recipients accepting each of the plurality of opportunities; and
determining a budget associated with a cost uptake of each of the plurality of opportunities by the plurality of recipients; and
wherein the quantum computer comprises a quantum computational unit configured to:
determine an optimized allocation of the opportunities to the recipients based on the respective likelihoods and the budget.
